(19) United States
(12) Patent Application Publication
(10) Pub. No.: US 2015/0079999 A1
(43) Pub. Date: Mar. 19, 2015

(54) DYNAMIC NETWORK ROUTING DECISION PROCESSES AND SYSTEMS

(71) Applicant: Highbeam Inc., New York, NY (US)

(72) Inventor: M. Erol TOKER, New York, NY (US)

(21) Appl. No.: 14/485,591

(22) Filed: Sep. 12, 2014

Related U.S. Application Data
(60) Provisional application No. 61/877,410, filed on Sep. 13, 2013.

(51) Int. Cl. H04W 40/16; H04M 1/253; H04M 9/02; H04L 12/857

(52) U.S. Cl. CPC H04W 40/16; H04L 47/2491; H04M 1/2535; H04M 9/025
USPC 455/445

(57) ABSTRACT

Systems, processes, and computer readable media are described for dynamically routing calls over one of a plurality of possible networks to a client device. A process comprises determining, by a processor, at least one characteristic of a voice communication path to a client device across a plurality of different networks, where one network includes an Internet routing service and another network includes a mobile or cellular network service. The process further includes initiating voice communication between a telephony server and the client device via one of the at least two different networks based on the at least one characteristic. The process may further include accessing data preferences associated with the client device, where initiating the voice communications is further based on the data preferences associated with the client device.

### CROSS-REFERENCE TO RELATED APPLICATION

This application claims priority from U.S. Provisional Ser. No. 61/877,410, filed on Sep. 13, 2013, entitled DYNAMIC NETWORK ROUTING DECISION PROCESSES AND SYSTEMS, which is hereby incorporated by reference in its entirety for all purposes.

### BACKGROUND

1. Field

The present disclosure relates generally to telephony services and, more specifically, to dynamically selecting network routing decisions of inbound and outbound calls across different types of networks (e.g., Internet Protocol based networks and mobile/cellular networks).

2. Related Art

Users of mobile phones today have access to inbound/outbound telephony services through multiple protocols, including a range of Voice Over Internet Protocol (VOIP) and mobile/cellular voice protocols. Use of either protocol at any given time involves the user to make a tradeoff along two key dimensions: cost and Quality of Service (QoS). (Of course, there are additional features for either protocols, but these two are generally key to the user experience.) VOIP calls are generally less costly than cellular voice service because the cost of transporting IP packet over the Internet is relatively low.

The second tradeoff between the different protocols is in the quality of the call, QoS, i.e., how reliable a connection is in terms of signal/packet loss (experienced by dropped calls or gaps in transmitted audio), jitter (experienced by disruptive fluctuations in audio signals) and latency (experienced by two people talking over each other). QoS can vary greatly across different LAN/WiFi networks and cellular networks depending on a variety of factors, including signal strength, device operations, and the like.

Accordingly, a user typically makes a manual determination at the time of the call or sets a default setting as to which network to use when making an outbound call and, more importantly, the user has no real-time control over which protocol their phone receives inbound calls. The choice of the wrong protocol can have material impact on the intangible and tangible value derived from real-time communication.

### SUMMARY

Systems and processes for dynamically routing calls over one of a plurality of possible networks to a client device are provided. In one embodiment, a process comprises determining, by a processor, at least one characteristic of a voice communication path to a client device across a plurality of different networks, where one network includes an Internet routing service and another network includes a mobile or cellular network service. The process further includes initiating voice communication between a telephony server and the client device via one of the at least two different networks based on the at least one characteristic. The process may further include accessing data preferences associated with the client device, where initiating the voice communications is further based on the data preferences associated with the client device.

The characteristic used for routing the voice communication may include one or more of a Quality of Service metric, a cost associated with the communication or network selected, or the like. The Internet routing service may include Voice Over Internet Protocol (VOIP) communications, and the cellular network service may include TDM communications.

According to another embodiment, a system is provided for dynamically routing calls over one of a plurality of possible networks to a client device. The system may include a processor and memory, the processor including logic operable to determine at least one characteristic of a voice communication path between a client device and a telephony service across a plurality of different networks, where one network includes an Internet routing service and another network includes a mobile or cellular network service. The processor may further include logic operable to initiate voice communication between the telephony server and the client device via one of the at least two different networks based on the at least one characteristic. The processor may further include logic operable for accessing data preferences, stored in the memory, associated with the client device, where initiating the voice communications is further based on the data preferences associated with the client device. The system may include a client device or server device, or combination of client device and server device.

Additionally, non-transitory computer readable storage medium is provided, the storage medium including instructions for carrying out one or more processes described.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary environment and system in which various aspects may be performed.

FIG. 2 illustrates a more detailed example of a system in which various aspects of the exemplary processes may be performed.

FIG. 3 illustrates an exemplary routing process for routing a call via one of a plurality of available network types.

FIG. 4 illustrates an exemplary routing process.

FIG. 5 illustrates an exemplary process by a client or server for selecting a network.

FIG. 6 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In one embodiment, a system and process are described for intelligently routing calls across mobile/cellular and IP networks (for both inbound and outbound calls), using data points that relate directly or indirectly to characteristics of telephony services such as the quality and cost of the communication. In particular, a client device may have the option for voice communication over a mobile network or an IP network, and the exemplary system and process may dynamically select one network over another based on user (and/or administrator) configuration preferences stored (e.g., with the client device or telephony service server). The selection may be based on preferences relating to the quality of the communication available via the available networks, cost of communication over the networks, security, and so on.

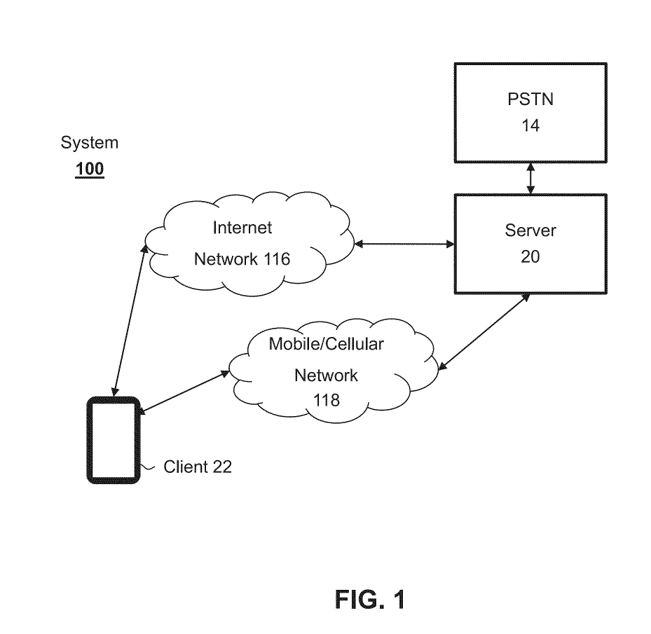

Initially, and with reference to FIG. 1, an exemplary environment in which certain aspects and examples of the systems and processes described herein may operate. Generally, a client device 22 may access a server 20, e.g., a telephony service provider, which includes or accesses logic for performing one or more exemplary processes described, e.g., providing dynamic network routing decisions, causing the display of interfaces for the client device, and so on. Server 20 and client 22 may include any one of various types of computer devices, having, e.g., a processing unit, a memory (which may include logic or software for carrying out some or all of the functions described herein), and a communication interface, as well as other conventional computer components (e.g., input device, such as a keyboard/touch screen, and output device, such as display). For example, client 22 may include a mobile device such as a mobile phone, web-enabled phone, or smart phone. Server 20 further communicates with a public switched telephone network (PSTN) 14 to connect or direct calls to and from client 22 to endpoints via PSTN 14.

Client 22 and server 20 may communicate, e.g., using suitable communication interfaces via a network 116, such as a Local Area Network (LAN) or the Internet. Client 22 and server 20 may communicate, in part or in whole, via wireless or hardwired communications, such as Ethernet, IEEE 802.11b wireless, or the like. Additionally, client 22 and server 20 may communicate, e.g., using suitable communication interfaces, via a second network, such as mobile/cellular network 118. Mobile/cellular network 118 may provide communications between client 22 and server 20 via conventional cellular communications methods, including, e.g., frequency division multiple access (FDMA), code division multiple access (CDMA), time division multiple access (TDMA), or the like. Communication between client 22 and server 20 may further include or communicate with various servers such as a mail server, mobile server, media server, telephone server, and the like.

One or both of client 22 and server 20 generally includes logic (e.g., http web server logic) or is programmed to format data, accessed from local or remote databases or other sources of data and content, for providing dynamic routing of calls via either network 116 or network 118. For example, client 22 and/or server 20 may include or access an application for storing routing preferences associated with client 22 (and/or server 20), processes for determining network characteristics, and routing incoming and outgoing calls accordingly. For example, in a simple case, determining which of networks 116 and 118 are available and routing accordingly. In more sophisticated examples, determining characteristics such as the strength or quality of the connection to each network, the cost of using each network, security available via each network, client or enterprise preferences, and the like, and routing based on predetermined rules or preferences (e.g., stored with the client 22 and/or server 22).

To this end, server 20 may utilize various web data interface techniques such as Common Gateway Interface (CGI) protocol and associated applications (or “scripts”), Java® “servlets,” i.e., Java® applications running on server 20, or the like to present information and receive input from client 22. The server 20, although described herein in the singular, may actually comprise plural computers, devices, databases, associated backend devices, and the like, communicating (wired and/or wireless) and cooperating to perform some or all of the functions described herein. Server 20 may further include or communicate with account servers (e.g., email servers), mobile servers, media servers, and the like.

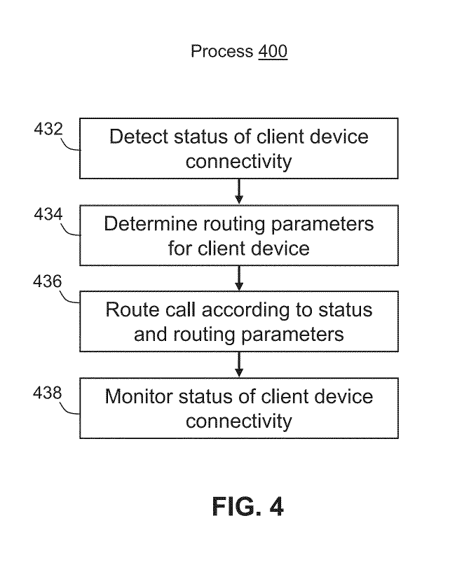

It should be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server 20 (and other servers and services described herein) generally include such art recognized components as are ordinarily found in server systems, including but not limited to processors, RAM, ROM, clocks, hardware drivers, associated storage, and the like (see, e.g., FIG. 4, discussed below). Further, the described functions and logic may be included in software, hardware, firmware, or combination thereof.

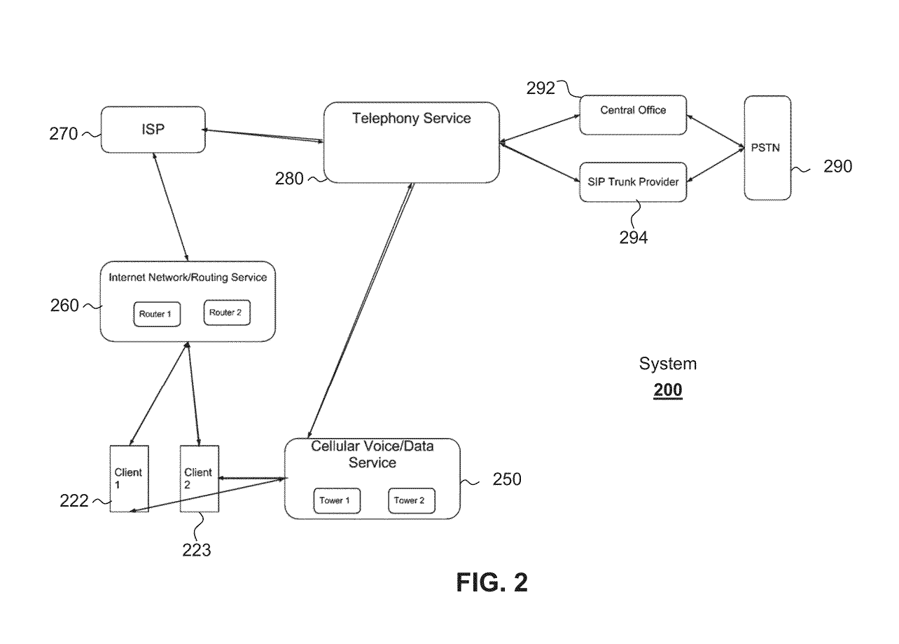

FIG. 2 illustrates a more detailed example of a system 200 in which various aspects of exemplary processes may be carried out. In this example, client devices 222, 223 are illustrated in communication through one or more data connections, e.g., with either a cellular service 250 or a network routing service 260. In turn, both the cellular service 250 and the network routing service 260 are operable to communicate with a telephony service server 280. The communications need not be direct, for example, the internet routing service 260 may communicate with telephony service 280 through an Internet Service Provider (ISP) 270 as illustrated.

The telephony service 280 may further communicate call communications and data with a PSTN 290, e.g., via a central office 292 or session initiation protocol (SIP) provider 294. For example, telephony service 280 can be connected to the PSTN through one or more interconnected entities, such as wireline/wireless telecom service providers or SIP trunking service providers. Further, the telephone service 280 may include an application server and a telephone server, which may be separate services or aggregated into a single service.

In one example, clients 222, 223 can broadcast changes in the identity and status of its network connections, including network name, physical/virtual IP address, media access control (MAC) address, cellular network signal, provider and client information including hardware, operating system (OS), and so on. Clients 222, 223 can initiate the broadcasts with a local client server. The broadcasts can be initiated or performed periodically (which may be set by the user or administrator), via a “subscription” to network change events delegated by the core OS, via a patch that's applied over the OS, or the like. In other examples, telephony service 280 can detect when clients 222, 223 are connected to an IP network or mobile network by periodically pinging the client and thus not require clients 222, 223 to initiate broadcasts.

In one example, telephony service 280 is operable to store configuration data that identifies and measures the identity and quality of any IP or cellular network available. For example, the quality of the IP or cellular network may include QoS guarantees that can be verified by the client and/or server, dropped calls measured by the telephony server (which is then mapped to the service utilized at the time), tracking network performance on an active connection, and so on. The measurements of quality may be carried out by telephony service 280 (and/or clients 222, 223 or other intermediate servers).

Telephony service 280 may be further operable to store and/or access preferences towards various call metrics such as QoS and cost for each client 222, 223. In one example, the clients 222, 223 broadcasts change events in the access preferences to telephony service 280. In other examples, telephony service 280 may be operable to detect a severing of an active socket connection, which infers that the client is inaccessible over an IP network, for example. Telephony service 280 may then dynamically select or compute a network to forward an incoming call across, e.g., a VOIP call via the Internet Network 260 or cellular network 250, based on the preferences and network characteristics.

In some examples, telephony service 280 may similarly select or compute a network for outgoing calls from clients 222, 223 in a similarly fashion. In other examples, clients 222, 223 may be operable to determine or compute the network locally based on network characteristics and client preferences, for example.

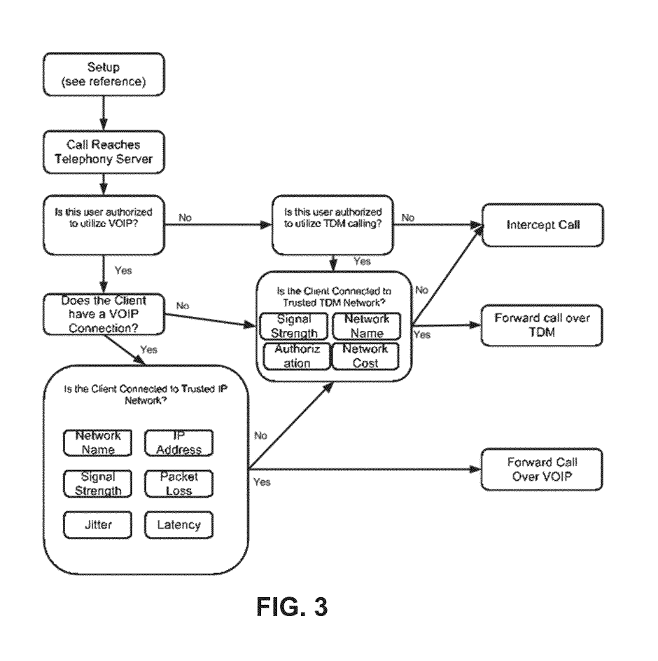

FIG. 3 illustrates an exemplary routing methodology for incoming calls via one of a plurality of available networks. The routing system and methodology is first setup, e.g., by a user or administrator. Initially, the user or administrator can associate a client device with a preference set that is used by the dynamic routing algorithm stored with the client device and/or the telephony service to determine optimal call paths through different networks. The dynamic routing algorithm may use user-based authorization data, trusted network information (e.g., network Type/SID/Name/IP-Range, reliability/uptime guarantees, and cost of the connection). The information may further include connection audit frequency, i.e., how often should the networks be polled to determine connectivity strength, cost, etc.

In the illustrated example, for an incoming call, the telephone service server is operable to first determine whether the target client device is authorized to utilize VOIP (e.g., based on user or administrator input preferences stored or accessible by the telephony server), and if not the server may then determine if the user is authorized to utilize TDM calling. If not, the call can be intercepted by the system (e.g., sent to voicemail, unavailable message, busy signal, or the like). If the call is authorized to utilize TDM calling, and is connected to a TDM network satisfying stored configuration or preference data, the call is forwarded to the client over TDM.

If the client device is authorized to use VOIP and either does not have a VOIP connection, or does not have a VOIP connection satisfying configuration preferences (e.g., relating to trusted network, IP address, signal strength, packet loss, jitter, latency, etc.), then the call may be similarly routed over TDM (if available and satisfying preferences) or intercepted. Where the VOIP connection does satisfy user preferences and is weighted more heavily than available cellular network(s), the call can be forwarded over VOIP.

To provide further context for the routing determinations, several use cases of how incoming and outgoing calls may be dynamically routed will now be described. Reference to FIGS. 1-3 may provide further context for the use cases.

### EXAMPLE 1

A user of a client device may be in an environment, e.g., an office environment, including a WiFi access point having traffic shaping implemented (prioritizing voice traffic) and sits on a separate physical network that has a dedicated T1 line with a high QoS from an Internet service provider. The user can enable WiFi on a client device and use an application to identify this as a “trusted network” or “preferred network,” where such identification is sent to a server, e.g., associated with or accessible by the client device and/or the telephone service via an internet-enabled network. The client device thereafter broadcasts the WiFi presence on the device to a server having IP connectivity, e.g., an application server or telephony server (along with other characteristics, e.g., strength of connection), which can then determine that the client is currently on a “trusted network.”

In response to an incoming (or outgoing call), the call can be routed through a central telephony server through a number on the PSTN or a SIP address. The telephony service routes the call over VOIP to the client device.

### EXAMPLE 2

Continuing from example 2, if the user missed the incoming call and attempts to return the call over the client device, i.e., an outgoing call, the client device may be operable to perform a lookup on a local/remote data store (e.g., the configuration data that identifies and measures the identity and quality of the IP and cellular networks) to detect whether the client device is on a trusted network connection. If the client device (or alternatively, the telephony service) recognizing the client device is connected to a trusted WiFi network with sufficient signal strength, the call can be dialed out via VOIP. If the preferences are not met, e.g., the signal strength is poor, and the cellular network is sufficient, the call can be dialed out via the cellular network.

### EXAMPLE 3

In a situation where a client device is engaged in a VOIP call and the application running on the client device is stopped through a direct process (e.g., manual shutdown) or accidental process (e.g., software crash, background process managed shutdown, etc.), the telephony service server may be operable to detect the loss of connectivity with the client device. The loss of connectivity may also be broadcast to the telephony server via the cellular service or Internet. In such an example, in response to an incoming call to the telephony server via PSTN number or SIP address, the telephony service can default to routing the call over the cellular network.

### EXAMPLE 4

In some situations a user may be in a public space, e.g., an airport, where the client device has access to one or more WiFi connections that are not identified as “trusted” or “secure” by stored configuration data/preferences, but may also have a weak cellular signal. For an incoming call via a PSTN number or SIP address, or an outgoing call, the server may identify the strength of the available networks (the WiFi signal and cellular signal) as well as the configuration data and routes the call accordingly. For example, the configuration data might direct the server to route the call over the cellular network over the VOIP network unless the cellular signal strength is below a threshold level.

FIG. 4 illustrates an exemplary process 400 for routing calls according to one example. Process 400 includes detecting a status of the connectivity of a client device at 432, e.g., the available networks and strength of connection to each. The process further determines, e.g., accesses or look-ups, stored preferences or configuration data for routing calls to the particular device at 434. The process is then operable to route the call according to the status of the available networks and the stored preference or configuration data at 436. The process may further monitor the status of the client device connectivity and network at 438, which may influence future routing decisions of incoming or outgoing calls.

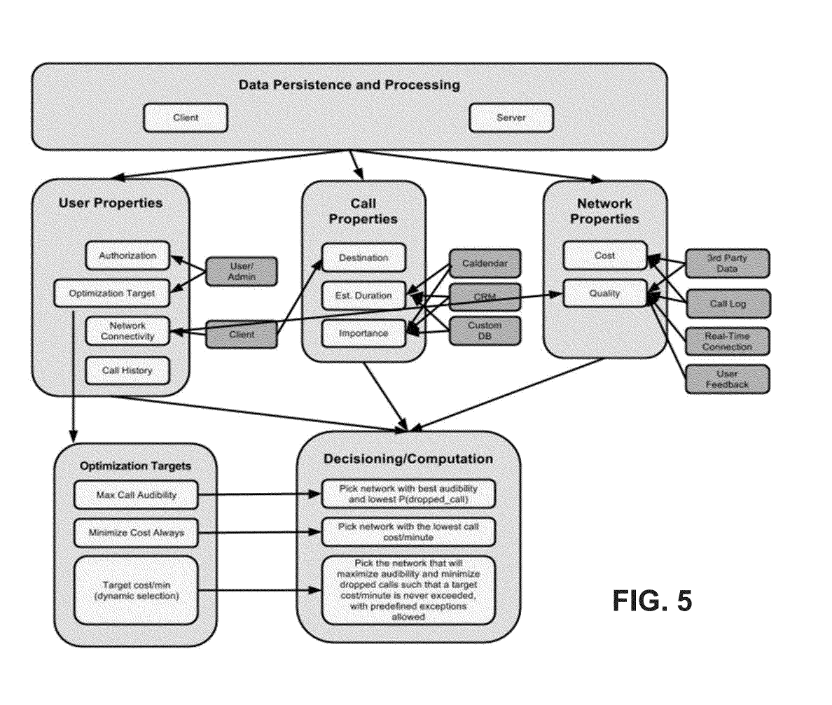

FIG. 5 illustrates an exemplary process that can be applied either by a client or a telephony server for selecting a network based on stored data and network characteristics. In this particular example, the client and server can have access to identical datasets, as follows:
“User Properties”—provides information about user authorization, network access, behavior, preferences, or the like. User properties may include information relating to current or historical network connectivity, call history, optimization targets, authorization, operating system, and so on.
“Call Properties”—provides information about the call itself, including destination (e.g., local or international), estimated duration, and the relative business value of the call, or the like. Call Properties may further include information pulled from a user's contacts, calendar, customer relations management data, or other databases.
“Network Properties”—provides information on the quality and cost of the network, using an aggregation of subjective (user-submitted, 3rd party aggregated), objective (connection state) data, or the like. Network properties may further include data pulled from third parties, call logs or historical data associated with the network and/or client devices, user feedback regarding network properties or call qualities.

In this example, the user may have the ability to select from a range of optimization targets that trade off quality (e.g., the probability of dropping a call and the probability of having a call without any audibility issues) for cost (e.g., the expected cost of using a specific network). These targets may include, for example:
“Maximizing Audibility”—always pick the network that will minimize dropped calls and provide the clearest connection.
“Minimizing Cost”—always pick the cheapest network available.
“Target cost/min”—select the network that will maximize audibility and minimize dropped calls such that a target cost/minute (spread over a client, a set of clients, an enterprise, or the service provider) is either never exceeded or achieved over time, allowing some calls to exceed this limit for calls that have substantial business value (e.g., calls with customers vs. internal calls).

One of skill in the art will recognize that the available data and targets used for the routing decisions may include more or less than illustrated in FIG. 5. For example, the optimization targets may vary based the destination number (e.g., for important business calls, maximize audibility; for personal calls, minimize cost), day or time of day (e.g., during business hours or weekdays maximize audibility or adjust the target cost/min), and so on.

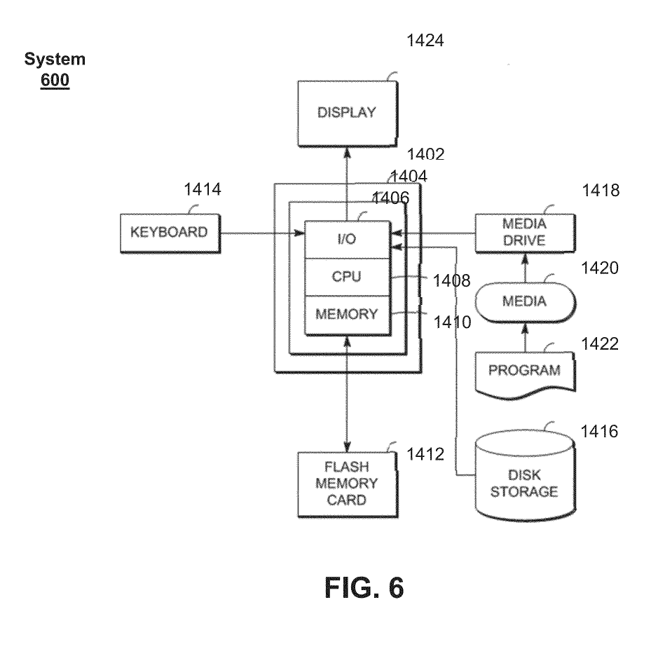

FIG. 6 depicts an exemplary computing system 600 configured to perform any one of the above-described processes. In this context, computing system 600 may include, for example, a processor, memory, storage, and input/output devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed is:

1. A computer-implemented method for routing calls over one of a plurality of possible networks to a client device, the method comprising:
at an electronic device having at least one processor and memory:
determining at least one characteristic of a voice communication path to a client device across a plurality of different networks, wherein one network of the plurality of networks includes an Internet routing service and another network of the plurality of networks includes a cellular network service; and
initiating voice communication between a telephony server and the client device via one of the at least two different networks based on the at least one characteristic.

2. The computer-implemented method of claim 1, further comprising accessing data preferences associated with the client device, and wherein the initiating voice communications is further based on the data preferences associated with the client device.

3. The computer-implemented method of claim 1, wherein the at least one characteristic includes a Quality of Service metric.

4. The computer-implemented method of claim 1, wherein the at least one characteristic includes a cost associated with the communication.

5. The computer-implemented method of claim 1, wherein the at least one characteristic includes a Quality of Service metric and cost of the communication.

6. The computer-implemented method of claim 1, wherein the Internet routing service comprises Voice Over Internet Protocol.

7. The computer-implemented method of claim 1, wherein the cellular network or wireline service comprises Time Division Multiplexing (TDM) or Voice Over LTE (VOLTE) protocol.

8. An electronic device having at least one processor and memory, the electronic device having logic operable to cause the at least one processor to:
determine at least one characteristic of a voice communication path to a client device across a plurality of different networks, wherein one network of the plurality of networks includes an Internet routing service and another network of the plurality of networks includes a cellular network service; and
initiate voice communication between a telephony server and the client device via one of the at least two different networks based on the at least one characteristic.

9. The electronic device of claim 8, further comprising logic operable to access data preferences associated with the client device, and wherein the initiating voice communications is further based on the data preferences associated with the client device.

10. The electronic device of claim 8, wherein the at least one characteristic includes a Quality of Service metric.

11. The electronic device of claim 8, wherein the at least one characteristic includes a cost associated with the communication.

12. The electronic device of claim 8, wherein the at least one characteristic includes a Quality of Service metric and cost of the communication.

13. The electronic device of claim 8, wherein the Internet routing service comprises Voice Over Internet Protocol.

14. The electronic device of claim 8, wherein the cellular network or wireline service comprises Time Division Multiplexing (TDM) or Voice Over LTE (VOLTE) protocol.

15. A computer readable storable medium comprising computer readable instructions operable to cause a processor to:
determine at least one characteristic of a voice communication path to a client device across a plurality of different networks, wherein one network of the plurality of networks includes an Internet routing service and another network of the plurality of networks includes a cellular network service; and
initiate voice communication between a telephony server and the client device via one of the at least two different networks based on the at least one characteristic.

16. The computer readable storage medium of claim 15, further comprising logic operable to access data preferences associated with the client device, and wherein the initiating voice communications is further based on the data preferences associated with the client device.

17. The computer readable storage medium of claim 15, wherein the at least one characteristic includes a Quality of Service metric.

18. The computer readable storage medium of claim 15, wherein the at least one characteristic includes a cost associated with the communication.

19. The computer readable storage medium of claim 15, wherein the at least one characteristic includes a Quality of Service metric and cost of the communication.

20. The computer readable storage medium of claim 15, wherein the Internet routing service comprises Voice Over Internet Protocol.

21. The computer readable storage medium of claim 15, wherein the cellular network or wireline service comprises Time Division Multiplexing (TDM) protocol.
